(19) United States
(12) Patent Application Publication
(10) Pub. No.: US 2017/0274416 A1
(43) Pub. Date: Sep. 28, 2017

(54) Applying a Coating to a Substrate; Composite Structures formed by Application of a Coating

(71) Applicant: Sung Wung YEOM, Fort Worth, TX (US)

(72) Inventor: Sung Wung YEOM, Fort Worth, TX (US)

(21) Appl. No.: 15/505,867

(22) PCT Filed: Sep. 1, 2015
(86) PCT No.: PCT/US2015/047962

§ 371 Date: Feb. 22, 2017

Related U.S. Application Data
(60) Provisional application No. 62/044,888, filed on Sep. 2, 2014.
(60) Provisional application No. 62/076,388, filed on Nov. 6, 2014.
(60) Provisional application No. 62/089,768, filed on Dec. 9, 2014.

(51) Int. Cl. B05D 1/12; C23C 24/04; C03C 17/00

(52) U.S. Cl. CPC B05D 1/12; C03C 17/008; C23C 24/04; B05D 2203/35; C03C 2217/23; C03C 2217/29; C03C 2218/17

(57) ABSTRACT

Composite structures composed of a coating applied to a substrate and provided, along with a process for applying a coating to a substrate to form the composite structure. Coatings described herein provide at least one of the following properties: nano-sized surface roughness; enhanced hydrophobic function; high transmittance; improved hardness; improved scratch resistance; and desirable bending properties. The coating method includes mixing coating particulates having an average particle diameter of 1 μm or less with a transfer gas, transferring the mixture to an application nozzle, and spraying coating particulates on the substrate under low pressure conditions to form a coating having an average particle diameter of 100 nm or less.

### CROSS-REFERENCE TO RELATED APPLICATIONS

The present application claims priority to U.S. Provisional Patent Application Ser. Nos. 62/044,888 filed Sep. 2, 2014, 62/079,388 filed Nov. 6, 2014, and 62/089,768 filed Dec. 9, 2014

### BACKGROUND

1. Field

The present disclosure relates to methods for applying a coating to a substrate, and to coated composite structures formed by application of a coating to a substrate. The present disclosure relates, more particularly, to providing coatings, including crystalline coatings, on substrates, such as non-crystalline substrates, and to coated composite structures formed thereby having desirable properties.

2. Description of the Related Art

Currently, thermal spray coating processes are widely used on a commercial basis. A characteristic feature of many thermal spray coating processes involves spray coating a metallic material having a high melting point on a base material through a rapid phase transition process using very high heat energy. According to may thermal spray coating processes, when operating process conditions are optimized, a coating can be provided having a thickness in a range of several micrometers (μm) to several millimeters (mm), and 3D coating can be achieved by employing various base materials during a spray process. Accordingly, thermal spray coating processes may demonstrate high reliability in coating materials requiring chemical resistance and abrasion resistance and are widely applied in a variety of fields, including aerospace, semiconductor and mechanical ship industries.

The popularity and profusion of electronic devices having displays, including touchscreen displays, has created needs for lightweight and durable housings and displays. GORILLA GLASS, a toughened glass substrate, is used for displays in many electronic devices, and it is tough and relatively scratch resistant. Sapphire glass is being developed for use in displays for electronic and other devices and has desirable hardness, clarity and scratch-resistant properties, but it is difficult to produce on a large scale and at attractive prices.

The present disclosure is directed to coating methods, materials and substrates, and to composite materials provided by coating various substrates. These methods, materials, substrates and composite materials provide desirable characteristics, including one or more of the following: clarity, high transparency, enhanced hydrophobic function, hardness, relatively low weight and low cost.

### SUMMARY

The present disclosure provides coatings having various compositions for application to various types of substrates, and to methods for applying such coatings to various substrates to produce composite structures. In some embodiments, the methods and compositions disclosed herein can provide a substantially transparent coating on a substantially transparent substrate to produce a substantially transparent composite structure having high transmittance and improved scratch resistance or hardness. Coatings applied to composite structures, as produced and described herein, may also provide oleophobic properties, and thereby provide improved anti-finger print and anti-smudging characteristics. In some embodiments, the surface(s) of composite structures, as produced and described herein, have increased surface contact angles and/or increased average surface roughness compared to the surface contact angles and/or average surface roughness of the underlying substrate. In some embodiments, application of the coating may minimize a bending phenomenon of the substrate. In general, the coatings described herein provide at least one of the following properties: nano-sized surface roughness; enhanced hydrophobic function; high transparency, high hardness and high transmittance.

In accordance with one aspect of the present disclosure, a method for coating a substrate is provided, comprising: mixing coating particles having an average particle diameter of 1 μm or less with a transfer gas; conveying the coating particles and transfer gas to an applicator comprising a nozzle; and spraying the coating particles on a substrate in a low pressure or partial vacuum environment while applying mechanical shocks to the substrate to provide a coating, on the substrate, having an average particle diameter of 100 nm or less. The coating method may be carried out at generally ambient temperatures.

In some embodiments, the coating has a thickness of less than 10 microns; in some embodiments, the coating has a thickness of less than 5 microns. In some embodiments, the coating has a thickness of 1000 nm or less. In some embodiments, the coating has an average particle diameter of 100 nm or less.

In some embodiments, the hardness of the composite structure, composed of the substrate having the coating applied, is increased compared to the hardness of the substrate. In some embodiments, the hardness of the composite structure is more than 1.2 times the hardness of the substrate; in some embodiments, the hardness of the composite substrate is more than 1.5 times the hardness of the substrate. In some embodiments, the hardness of the composite structure is more than 2 times the hardness of the substrate.

In some embodiments, the substrate is substantially transparent and the composite structure, comprising the substrate with a coating applied to it, has a transmittance of at least 85% the transmittance of the substantially transparent substrate. In some embodiments, the composite structure has a transmittance of at least 95% the transmittance of the substantially transparent substrate.

In some embodiments, the composite structure, composed of a substrate having the coating applied, has a higher scratch resistance than that of the substrate. In some embodiments, a bending phenomenon of the substrate is reduced by application of a coating as described herein. Additional information and details concerning the composition of the coating, the composition of the substrate, the coating process, and the properties of coated substrates are provided below.

### BRIEF DESCRIPTION OF THE DRAWINGS

The above and other features and advantages of the present invention will become more apparent by describing various embodiments thereof with reference to the attached drawings in which:

FIG. 1 is a schematic diagram illustrating an apparatus for forming a transparent composite structure according to an embodiment of the present disclosure;

FIG. 2 is a flowchart illustrating a forming method of a transparent composite structure according to an embodiment of the present disclosure;

FIG. 3A is a graph illustrating hardness of a transparent composite structure as a function of coating thickness according to an embodiment of the present disclosure;

FIG. 3B is a graph illustrating hardness of a transparent composite structure as a function of additional coating thicknesses according to an embodiment of the present disclosure;

FIG. 4A is a graph illustrating transmittance of a transparent composite structure as a function of coating thickness according to an embodiment of the present disclosure;

FIG. 4B is a graph illustrating transmittance of a transparent composite structure as a function of additional coating thicknesses according to an embodiment of the present disclosure;

FIG. 4C shows X-ray diffraction analysis of the corundum structure of as-deposited crystalline sapphire coating as described herein;

FIG. 5A is a graph illustrating the bending of a composite structure as a function of the coating thickness according to an embodiment of the present disclosure;

FIG. 5B is a cross-sectional view illustrating the bending of a composite structure as disclosed herein;

FIG. 6A is a graph illustrating contact angles of a coated composite structure as a function of coating thickness according to an embodiment of the present disclosure;

FIG. 6B is a graph illustrating contact angles of a coated composite structure as a function of coating thickness according to an embodiment of the present disclosure;

FIG. 7A is a graph illustrating average surface roughness of a composite structure as a function of coating thickness according to an embodiment of the present disclosure;

FIGS. 7B to 7D illustrate atomic force microscope (AFM) results showing the average surface roughness as a function of coating thickness, with FIG. 7B illustrating a coating thickness of 20 nm, FIG. 7C illustrating a coating thickness of 170 nm, and FIG. 7D illustrating a coating thickness of 350 nm;

FIGS. 8A to 8C are photographs of a transparent composite structure according to an embodiment of the present disclosure;

FIG. 9 shows a summary of comparative properties of crystalline sapphire coated GORILLA GLASS fabricated as described herein, GORILLA GLASS without a coating applied, and single crystalline sapphire glass.

### DETAILED DESCRIPTION

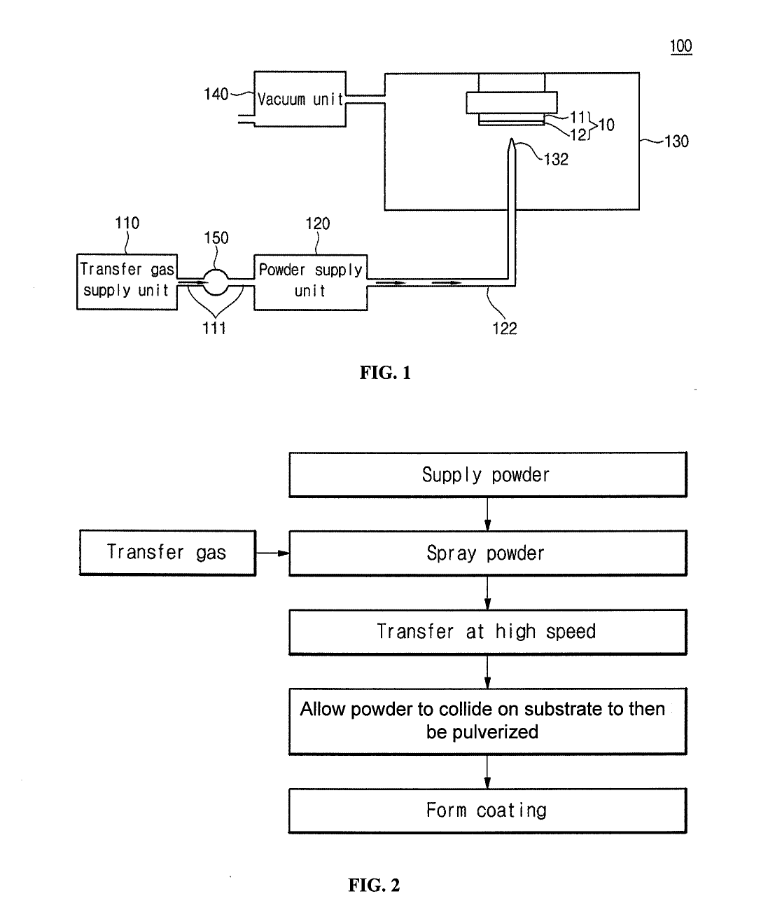

FIG. 1 is a schematic diagram illustrating a system for coating a substrate to form a composite structure according to one embodiment of the present disclosure, and FIG. 2 is a flowchart illustrating a coating method for applying a coating to a substrate to provide a composite structure according to an embodiment of the present disclosure.

As illustrated in FIG. 1, the coating system 100 according to one embodiment of the present disclosure includes a transfer gas supply unit 110, a coating supply unit 120 storing and supplying coating particulates, a transfer conduit 122 transferring coating particulates from the coating supply unit 120 at high speed using a transfer gas, a nozzle 132 for coating, stacking, applying and/or spraying the coating particulates from the transfer pipe 122 to the substrate 11 within a processing chamber 130 for applying a coating 12 to substrate 11, forming composite structure 10. Gas flow rate and/or volume controller 150 may be provided to monitor and control the gas flow rate and/or gas volume and/or gas composition introduced to the powder supply unit.

Application of a coating having a predetermined thickness may be accomplished by allowing the coating particulates ejected from nozzle 132 to strike the substrate at a high velocity, resulting in fragmentation and pulverization of the coating particulates as the coating is applied. The transfer gas stored in the transfer gas supply unit 110 and used for transferring coating particulates during the coating process may include a gas selected from the group consisting of: oxygen, helium, nitrogen, argon, carbon dioxide, hydrogen and equivalents thereof, and mixtures including two or more of these materials, or mixtures containing at least one of these gases with another gas, but aspect of the coating process are not limited thereto. The transfer gas may be directly supplied from the transfer gas supply unit 110 to the powder supply unit 120 through a conduit 111, and the flow rate and pressure of the transfer gas may be controlled by the flow rate and/or volume controller 150.

The powder supply unit 120 stores and supplies a large amount of coating particulates. The coating particulates may have an average particle size in the range of 10 nm to 1 μm. For many embodiments, the average particle size of the coating particulates is desirably smaller than 1 μm to avoid a sand blasting effect and to preserve a high transmittance of the coated substrate. For many embodiments, the average particle size of the coating particulates is desirably larger than 10 nm.

The interior of processing chamber 130 is maintained under low pressure, partial vacuum conditions during application of the coating 12. To this end, a vacuum supply unit 140 may be connected to the processing chamber 130. In some embodiments, the interior of the processing chamber 130 may be maintained at a pressure in a range of approximately 1 Pa to approximately 800 Pa during application of a coating. In some embodiments, the pressure within transfer conduit 122 during transfer of coating particulates in the transfer gas may be maintained a pressure in a range of approximately 10 Pa to approximately 2000 Pa. In many embodiments, the pressure within the transfer conduit 122 is desirably greater than the pressure within processing chamber 130.

Application of coating particulates to a substrate in this system and under these conditions may be performed at room temperature using a high speed scanning system to provide substantially uniform nano-articulate stream control and a substantially uniform and reproducible coating. The process is generally carried out at temperatures of less than 100 deg. C, and often at temperatures of less than 50 Deg. C. In many embodiments, the process may be carried out at ambient temperatures.

The coating particulates for forming the coating 12 may comprise alpha alumina (α-Al₂O₃), which is a brittle material. The coating particulates sprayed through nozzle 132 collide with the substrate 11 in the processing chamber and are fragmented and/or crushed and/or pulverized when they contact the surface of the substrate to provide a coating that adheres to the substrate and provides desirable properties. In many embodiments, particles forming the coating applied to the substrate have an average particle diameter that is smaller than an average particle diameter of the coating particulates applied to form the coating. In some embodiments, the average particle diameter of the coating applied to the substrate may be in a range of from about 1 nm to 100 nm.

Meanwhile, as described above, a pressure difference between the processing chamber 130 and the transfer conduit 122 (or the transfer gas supply unit 110 or the powder supply unit 120) may desirable by approximately 1.5 times to 2000 times, with the pressure in the processing chamber being lower than the pressure in the transfer conduit. The pressure difference facilitates high-speed transfer and application of powder from the transfer conduit to a substrate located in the processing chamber using nozzle 132. The pressure difference is desirably greater than approximately 1.5 times to promote application of the powder to the substrate at a high speed. The pressure difference is desirably less than approximately 2000 times to prevent etching or over-etching a surface of the substrate.

In addition, nozzle 132, which communicates with the transfer conduit 122 and sprays the coating particulates during application to the substrate is desirably configured to facilitate collision of the coating particulates with the substrate at a speed greater than approximately 100 m/s. The application speed of the coating particulates during application to the substrate is desirably less than approximately 1500 m/s. Under these application conditions, the coating particulates are fragmented and/or crushed and/or pulverized as they contact the substrate as a result of kinetic energy produced when the coating particulates are transferred through nozzle 132 and the collision energy generated during high-speed impact of the particles with the substrate. A coating having a desired predetermined thickness is thereby formed on the surface of the substrate to form a coated composite structure.

In the present disclosure, alpha alumina is exemplified as a brittle material. However, alpha alumina may include one or a mixture of two materials selected from the group consisting of alumina (Al₂O₃), yttria (Y₂O₃), YAG (Y₃Al₅O₁₂), a rare earth element series (atoms ranging from atom numbers 57 to 71, including Y and Sc) oxide, bio glass, silicon dioxide (SiO₂), hydroxyapatite, titanium dioxide (TiO₂), equivalents thereof, and mixtures thereof.

In more detail, the coating particulates for application to substrates using the coating process described herein may comprise at least one material, or a mixture materials, selected from the group consisting of alpha alumina, alumina, hydroxyapatite, calcium phosphate, bio glass, Pb(Zr,Ti)O₃ (PZT), titanium dioxide, zirconia (ZrO₂), yttria (Y₂O₃), yttria stabilized zirconia (YSZ), dysprocia (Dy₂O₃), gadolinia (Gd₂O₃), ceria (CeO₂), gadolinia doped ceria (GDC), magnesia (MgO), barium titanate (BaTIO₃), nickel manganite (NiMN₂O₄), potassium sodium niobate (KNaNbO₃), bismuth potassium titanate (BiKTiO₃), bismuth sodium titanate (BiNaTiO₃), CoFe₂O₄, NiFe₂O₄, BaFe₂O₄, NiZnFe₂O₄, ZnFe₂O₄, MnₓCo₃₋ₓO₄ (where x is a positive real number of 3 or less), bismuth ferrite (BiFeO₃), bismuth zinc niboate (Bi₁₋₅ZN₁Nb_{1.5}O₇), lithium phosphate aluminum titanium glass ceramic, Li—La—Zr—O based garnet oxide, Li—La—Ti—O based perovskite oxide, La—Ni—O based oxide, irong lithium phosphate, lithium-cobalt oxide, Li—Mn—O based spinel oxide, lithium phosphate aluminum gallium oxide, tungsten oxide, tin oxide, nickel lanthanum oxide, lanthanum-strontium-manganese oxide, lanthanum-strontium-iron-cobalt oxide, silicate based phosphor, SiAlON based phosphor, aluminum nitride, silicon nitride, titanium nitride, AlON, silicon carbide, titanium carbide, tungsten carbide, magnesium boride, titanium boride, a mixture of metal oxide and metal nitride, a mixture of metal oxide and metal carbide, a mixture of ceramic and polymer, a mixture of ceramic and metal, nickel, copper, silicon, and equivalents thereof. It will be appreciated that different compositions of coating particulates may be applied to the same or different substrates using the coating process described herein to provide coated substrates having a variety of compositions and properties. Different coating compositions may be selected for application to substrates having different compositions, configuration, properties, and the like, using the coating methodology as described herein.

The substrate 11 may be transparent and may include at least one material selected from the group consisting of glass by which we mean many types and compositions of glass, including, without limitation, GORILLA GLASS, plastic, by which we man many types and compositions of plastic, including, without limitation, polycarbonates (PC), polyamides (PA), polyimides (PI), polybutylene terephthalates (PBT), polyethylene terephthalates (PET), polyether imides (PEI), polyphenylene sulfides (PPS), polyether ketones (PEK), polyether ether ketones (PEEK) and polymethyl methacrylates (PMMA). The substrate may also be a sapphire (e.g., single crystal) substrate, or a metal, ceramic or fiber-reinforced material substrate. The substrate may be a single-layered substrate made of a single material. Alternatively, the substrate may be a multi-layered substrate composed of different materials stacked in multiple layers or otherwise joined to provide a substrate.

For example, the substrate may comprise a single-layered substrate made of GORILLA GLASS; alternatively, it may comprise sapphire “glass” (e.g., single crystal sapphire) or a multi-layered substrate comprising glass and polycarbonate stacked (or otherwise arranged in multiple layers. In one embodiment, the coating technology and system described above may be implemented to apply a highly transparent crystalline (e.g., sapphire) coating to non-crystalline glass, such as GORILLA GLASS, to provide a highly transparent crystalline sapphire coating on a GORILLA GLASS substrate. Dry non-sized sapphire powders may be used as a coating and applied as a fine stream of non-sized sapphire powder to a substrate in a low pressure system as described.

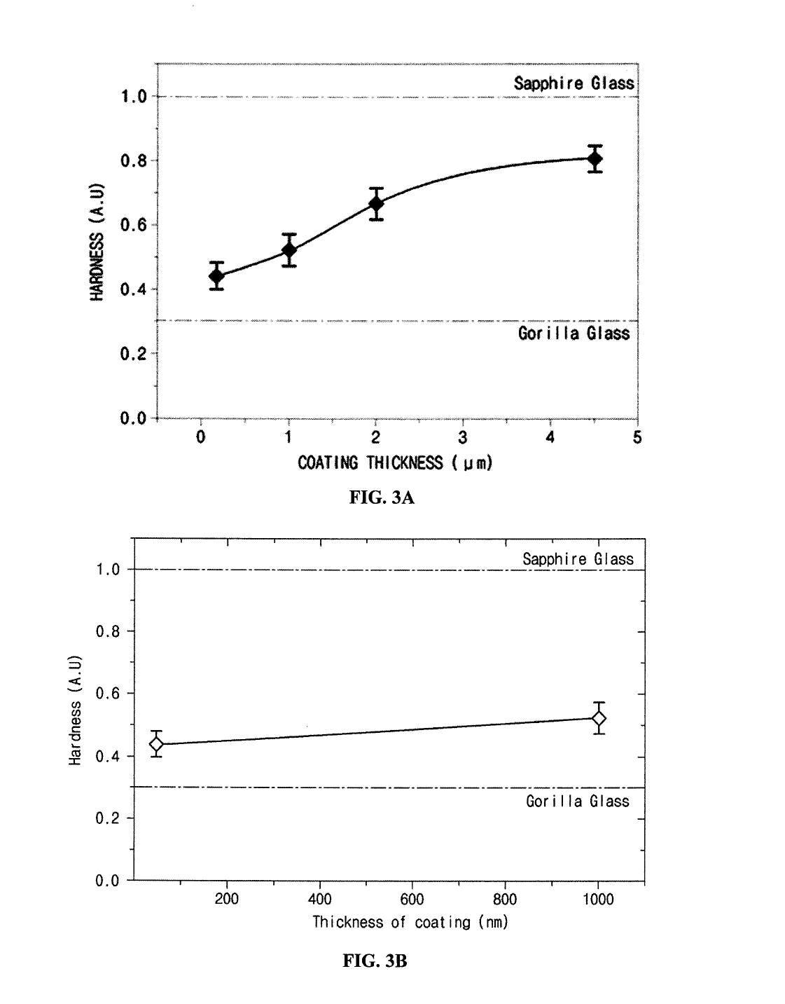

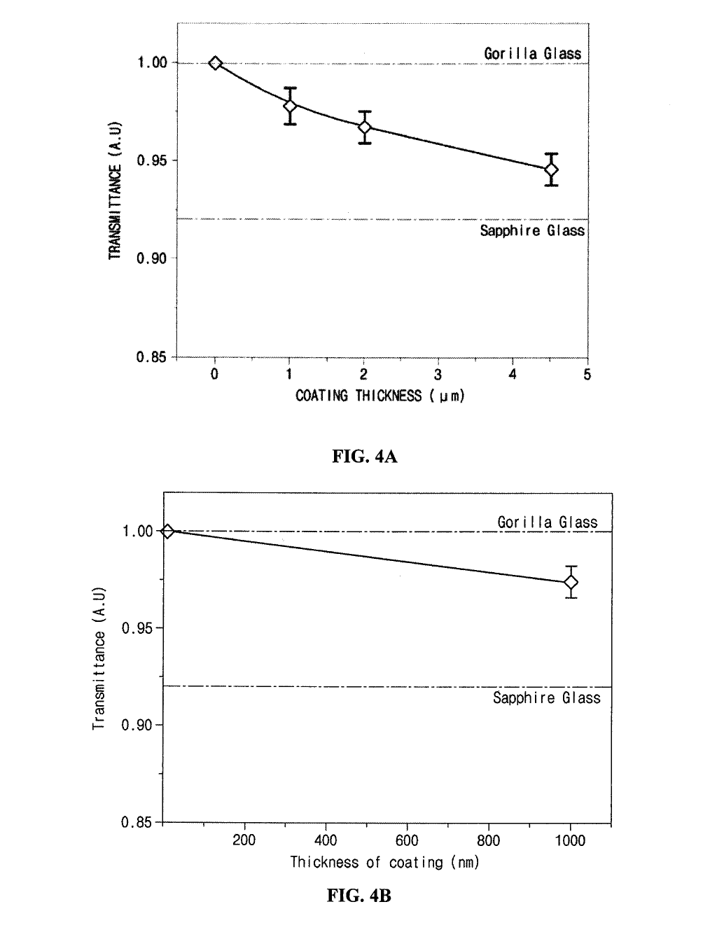

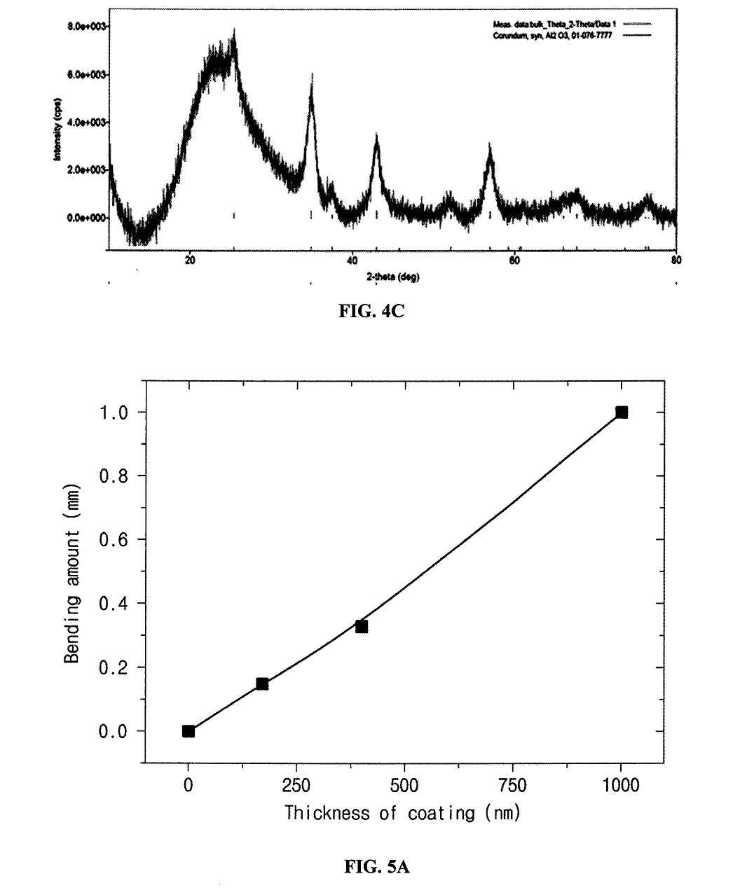

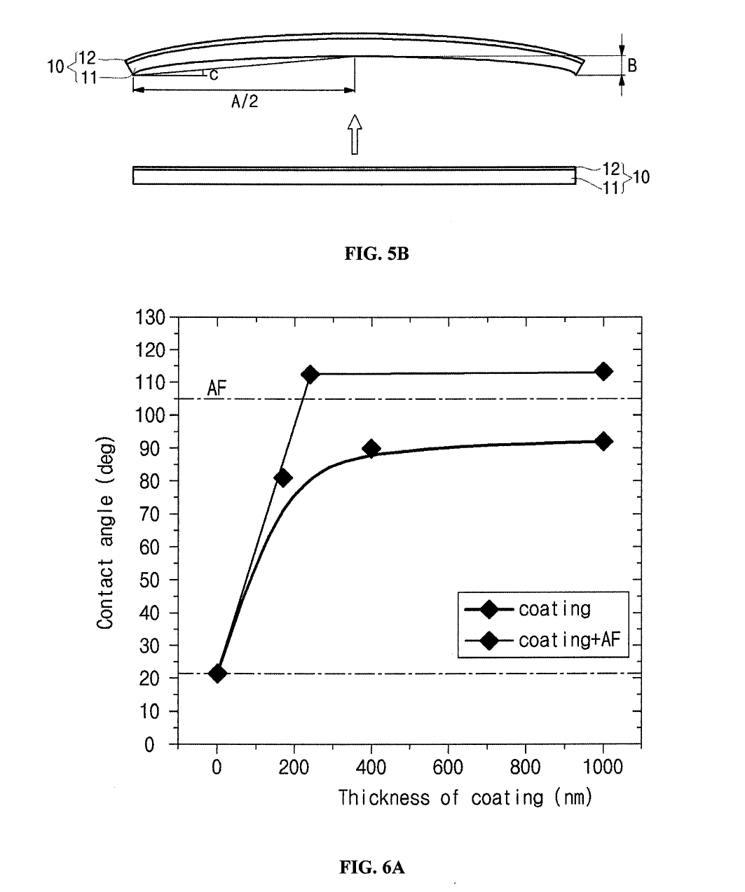

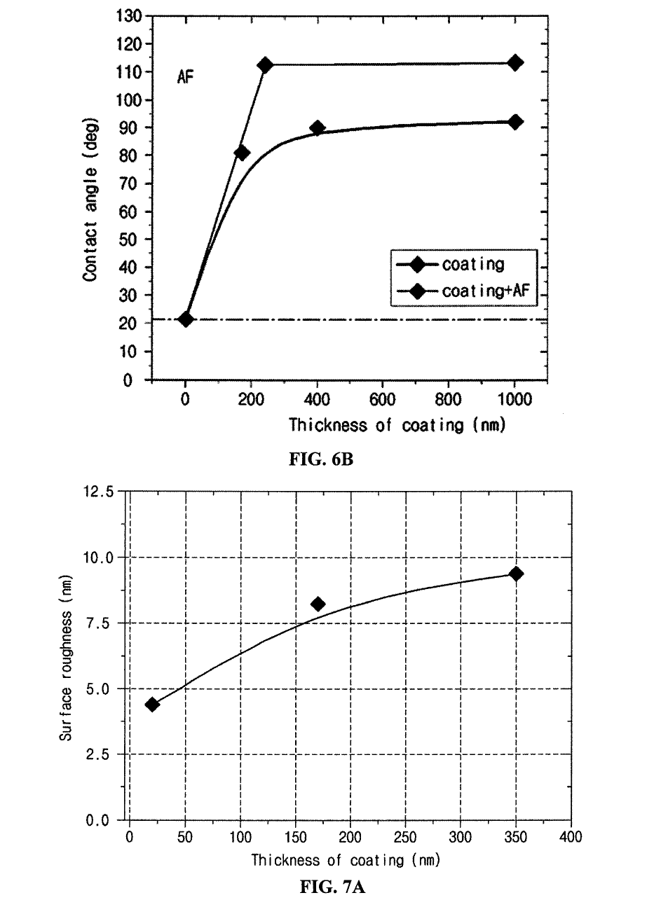

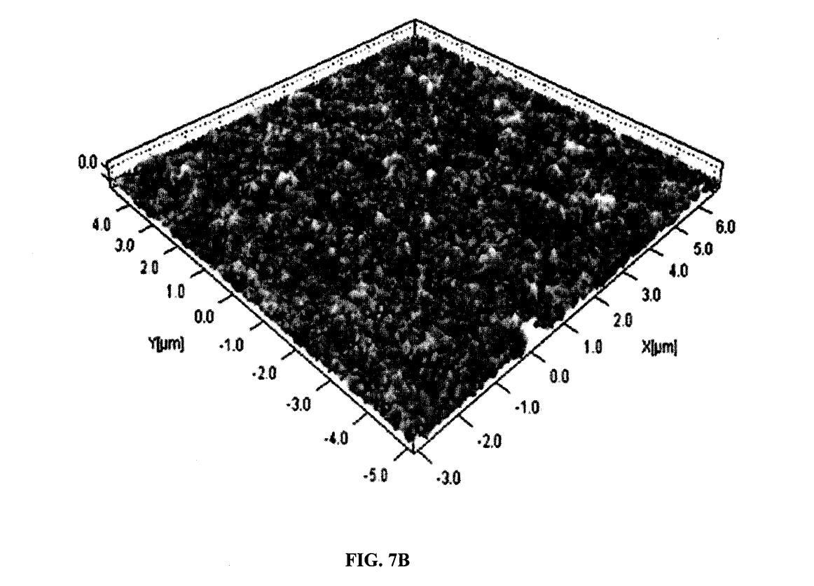

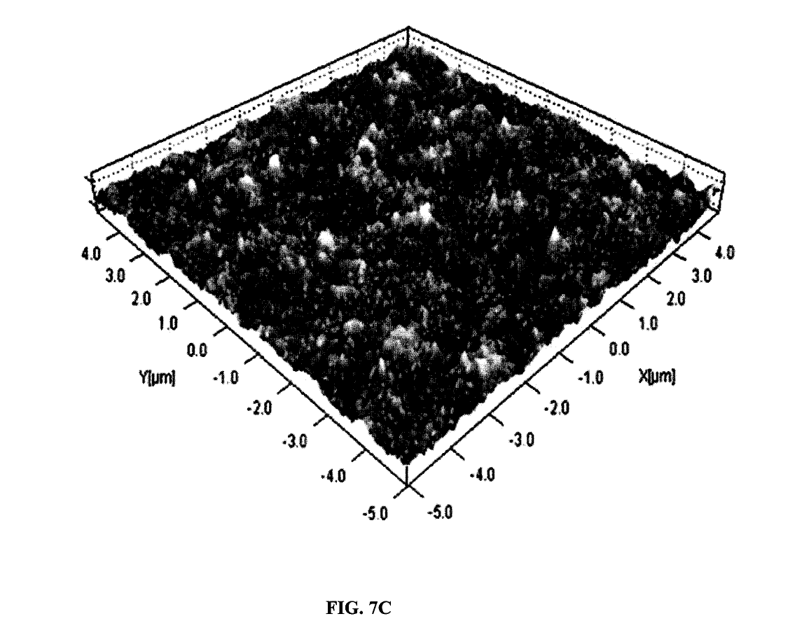

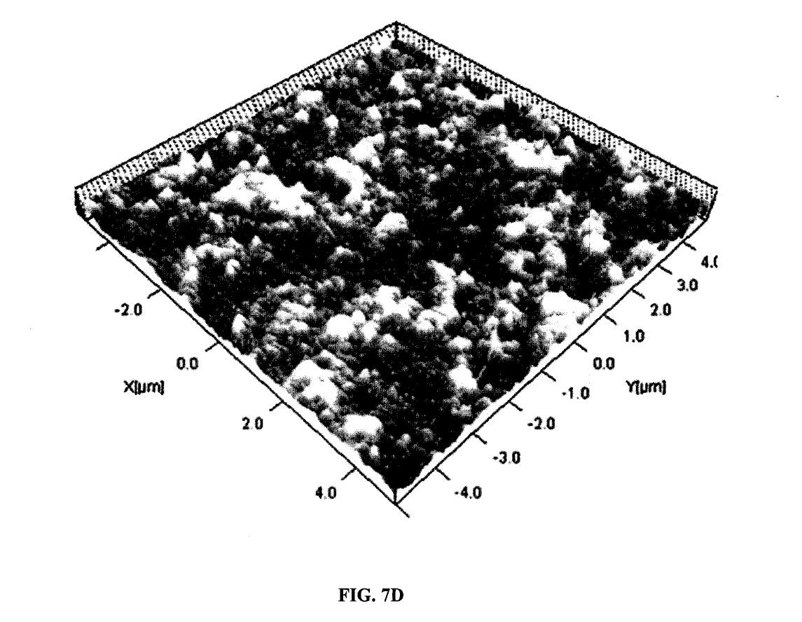

Coating compositions as described herein were applied to substrates using the process described herein and properties of the composite structures were determined experimentally. Nano-sized alpha-alumina was used as the coating composition and was applied to GORILLA GLASS to provide a sapphire-coated GORILLA GLASS composite structure. FIGS. 3A and 3B are graphs illustrating the hardness of the composite structure as a function of coating thickness; FIGS. 4A and 4B are graphs illustrating transmittance properties of the composite structure as a function of coating thickness; FIGS. 5A and 5B illustrate bending properties of composite structure as a function of coating thickness; FIGS. 6A and 6B show graphs illustrating the contact angle as a function of coating thickness; and FIG. 7A shows a graph illustrating the surface roughness as a function of coating thickness.

In FIGS. 3A and 3B, the X-axis indicated the thickness (μm) of a coating and the y-axis indicates the Vickers hardness (HV) of a transparent substrate. The hardness of the transparent sapphire-coated GORILLA GLASS composite structure was analyzed using a nano indentation device, e.g., HM2000s. In addition, the hardness of the composite structure was measured based on a ratio of the hardness of the GORILLA GLASS substrate to the hardness of the sapphire-coated GORILLA GLASS composite structure, and the hardness values are compared to the hardness of Sapphire “glass,” shown having a hardness of “I”.

As shown in FIGS. 3A and 3B, the hardness of the sapphire-coated GORILLA GLASS composite structure increases as the thickness of the coating increases. Application of the coating increases the hardness of the substrate, and the hardness of the composite structure increases as the thickness of the coating increases. The experimental date shows that the hardness of the sapphire-coated GORILLA GLASS composite structure increases by a factor of greater than 1.5 times, compared to the hardness of GORILLA GLASS (0.3) when the coating has a thickness in a range of 100 nm to 1000 nm. In general, application of a coating as described herein increases the hardness of the substrate by a factor of at least 1.2, and in some embodiments by a factor of at least 1.5. The composite structure may have hardness or 700 HV or greater, depending on the substrate material when the coating applied has a thickness in a range of 100 nm 1000 nm.

Additional hardness properties of a nano-sized sapphire coatings applied to GORILLA GLASS using the coating technology described herein were measured and compared. GORILLA GLASS has a Vickers Hardness of approximately 650-700 HV. Application of an alpha-alumina coating having a thickness of from about 1-3 μm to GORILLA GLASS using the process described herein, for example, increases the hardness of the composite structure to approximately 1000-1900 HV, which represents an increase of hardness by a factor of approximately 1.5-3, and approaches the hardness of single crystal Sapphire glass, which has a hardness of approximately 2100-2300 HV.

In FIGS. 4A and 4B, the X-axis indicates the thickness (μm) of a coating and the y-axis indicates the relative transmittance (%) of the composite (coated) structure compared to the transmittance of the substrate, which is assigned to a transmittance value of 1.00. The transmittance of the crystalline sapphire-coated GORILLA GLASS composite structure was analyzed using a UV/VIS spectrophotometer, e.g., MECASYS OPTIZEN 2120, by irradiating the coated substrate with wavelengths in a visible light range and measuring the amount of visible light transmitted through the composite structure. Sapphire glass has a lower transmittance than GORILLA GLASS, and Sapphire glass has a lower transmittance than any of the sapphire-coated GORILLA GLASS composite structures tested, as shown in FIGS. 4A and 4B.

As shown in FIGS. 4A and 4B, the relative transmittance of the sapphire-coated GORILLA GLASS composite structure decreases as the thickness of the coating increases. The relative transmittance of the sapphire-coated GORILLA GLASS composite structure was reduced to 97-98% compared to the transmittance of GORILLA GLASS when the coating had a thickness of 1000 nm; the relative transmittance of the sapphire-coated GORILLA GLASS composite structure was reduced to approximately 95% compared to the transmittance of GORILLA GLASS when the coating had a thickness of 4-5 μm. The relative transmittance of Sapphire glass was 92% of that of GORILLA GLASS. Thus, when the sapphire coating on GORILLA GLASS has a thickness of 1000 nm or less, the transmittance of the sapphire-coated GORILLA GLASS composite structure is higher than the transmittance of Sapphire glass.

The relative transmittance of a transparent composite structure may vary according to the composition of a substrate. The absolute transmittance of GORILLA GLASS is approximately 91-92%; the absolute transmittance of Sapphire glass is approximately 85-86%, and the absolute transmittance of the sapphire-coated GORILLA GLASS composite structure described herein having a coating thickness of up to about 1 μm is approximately 88-90%. Thus, when the sapphire coating has a thickness of 1000 nm or less, the absolute transmittance of the coated substrate is higher than the absolute transmittance of Sapphire glass.

FIG. 4C illustrates the X-ray diffraction analysis of the corundum structure of the as-deposited sapphire film on GORILLA GLASS.

FIGS. 5A and 5B show a graph and a cross-sectional view illustrating bending of a sapphire-coated GORILLA GLASS composite structure according to an embodiment of the present disclosure. In FIG. 5A, the X-axis indicates the thickness (nm) of a coating and the Y-axis indicates the bending amount of the composite structure. The bending amount (b) of the composite structure was measured by setting lengths of diagonal lines of the transparent composite structure 10 to 5 inches, fixing facing diagonal corners to a planar fixing plate and inserting a clearance gauge into the center of the plate.

As shown in FIG. 5A, as the coating thickness increases, residual stress increases as a result of the stress applied when the coating is applied, thereby increasing the bending amount (B). When the coating had a thickness of 1000 nm, the bending amount (b) was 1000 μm. FIG. 5B is a cross-sectional view of a transparent composite structure, illustrating the bending amount (b) depending on the length (a) of the transparent composite structure. Here, the length (A) of the transparent composite structure may be one of a length of one side and a distance between facing diagonal corners, but aspects of the present disclosure are not limited thereto. The bending angle (C) of the composite structure may be represented by the following equation (1):

$$tan ( C ) = \frac{B}{( \frac{A}{2} )} \qquad ( 1 )$$

where B denotes the bending amount shown in FIG. 5B and A denotes the length of the transparent composite structure. When the length (A) of the transparent composite structure 10 is constant, the coating may be formed to have a predetermined thickness or less to reduce the bending angle (C), thereby reducing the bending amount (B).

When the coating thickness of the composite (coated) structure is in a range of 100 nm to 1000 nm, the bending angle (C) of the composite structure may be in a range of 0.005° to 3°. In general, composite structures having a bending angle (C) of 3° or less are desired and, in many embodiments, the coating is preferably applied to have a thickness of 1000 nm or less provided a composite structure having a bending angle (C) of 3° or less.

As shown in FIGS. 3A-C, 4A-C, 5A and 5B, as the thickness of the composite structure coating increases, the hardness of the composite structure generally increases, the transmittance of the composite structure may be decreased, and the bending amount of the composite structure may increase. In many embodiments, it is desirable to minimize a reduction in the transmission while increasing scratch resistance (by increasing hardness) of the composite structure. In many embodiments, the composite structure is preferably fabricated to have a coating thickness in a range of 100 nm to 1000 nm, providing desired hardness and transmittance properties, while also providing a bending angle (C) of 3° or less.

If the coating of the composite structure has a thickness of less than 100 nm, it is possible to reduce the decrease in transmittance. But, with very thin coating, the increase in the hardness of the composite structure is so negligible that the scratch resistance may not be improved. If the coating of the composite structure has a thickness of greater than 1000 nm, the scratch resistance may be improved, but the transmittance may be lowered and the bending angle may be increased. Accordingly, for planar substrates, such as those used in flat (substantially planar0 display products, the thickness of the coating is generally more than 100 nm and less than 1000 nm. For substantially planar display products, such as those in which a coating is applied to a substantially flat surface such as a glass or plastic substrate, such as GORILLA GLASS, a coating comprising nano-sized particles, such as nano-sized alumina and alpha-alumina particles may be applied to a thickness of more than 100 nm and less than 1000 nm. The present disclosure is directed to composite structures having such compositions for use as electronic display products.

FIGS. 6A and 6B show graphs illustrating contact angles of a composite structure composed sapphire-coated GORILLA GLASS according to an embodiment of the present disclosure and FIG. 7A is a graph illustrating average surface roughness of a sapphire-coated GORILLA GLASS composite structure according to an embodiment of the present disclosure. FIGS. 7B to 7D illustrate atomic force microscopy (AFM) images of a sapphire-coated GORILLA GLASS composite structure as described herein, shown at different magnifications. Anti-fingerprint (AF) characteristics of the transparent composite structure are described below with reference to FIGS. 6A-B and 7A-D.

In FIGS. 6A and 6B, the X-axis indicates the thickness (nm) of the coating and the Y-axis indicates the surface contact angle (°) with respect to water. The contact angle of the transparent composite structure 10 was measured by wettability determination, i.e., by irradiating water drops applied to the coating and measuring a contact angle between the surface of the composite structure and a water drop using a photographed image. The substrate used in measuring for comparison of measured contact angles was GORILLA GLASS, which has a surface contact angle of 20° with respect to water.

As shown in FIGS. 6A and 6B, as the thickness of the coating increases between 0 and 400 nm, the surface contact angel with respect to water is sharply increased. In addition, after reaching a contact angle of approximately 90° when the coating has a thickness of about 400 nm or greater, increased coating thickness produces a negligible change in the surface contact angle with respect to water. In general, as the surface contact angle with respect to water is increased, a higher water repelling property is exhibited and the anti-smudging and anti-fingerprint (AF) characteristics are improved. For purposes of providing enhanced anti-smudging and anti-fingerprint properties when sapphire coatings are applied, sapphire coatings having a thickness of 100 nm or greater and providing a contact angle of 60° or greater are preferred. For some applications, sapphire coatings having a thickness of 400 nm or greater, providing a contact angle and water repelling property of 90° or greater, are preferred.

In FIG. 7A, the X-axis indicates the thickness (nm) of a coating and the Y-axis indicates the average surface roughness Ra of the coated surface. The average surface roughness of the coating was measured by observing surface shapes and displacement based on atomic repulsion while moving an atomic force microscope (AFM) probe. FIGS. 7B-7D show AFM scans illustrating the surface roughness of sapphire coatings having different thicknesses. As shown in FIGS. 7A-7D, as the thickness of the coating increases, the average surface roughness Ra also increases, which improves the anti-smudging and anti-fingerprint properties of the composite structure. When the coating has a thickness of 100 nm or greater, the transparent composite structure may have an average surface roughness of 5 nm or greater. Composite structures having a coating exhibiting a surface roughness of at least 5 nm are preferred for many applications; composite structures having a coating exhibiting a surface roughness of at least 7.5 nm are preferred for many applications.

FIG. 7B illustrates AFM results of a sapphire coating applied as described herein having a thickness of 20 nm. Here, the average surface roughness is 4.4 nm. FIG. 7C illustrates AFM results of a sapphire coating applied as described herein having a thickness of 170 nm. Here, the average surface roughness is 8.25 nm. FIG. 7D illustrates AFM results of a coating having a thickness of 350 nm. Here, the average surface roughness is 9.3 nm. As shown in FIGS. 7A to 7D, as the thickness of the coating increases, the surface roughness also increases.

In some applications, it is desirable to apply one or more additional surface coating(s) to a composite structure as described herein, using one or more separate processes, to provide a composite structure exhibiting improved surface characteristics, such as improved anti-smudging and anti-fingerprint (AF) characteristics. In some embodiments, an AF coating is applied to a composite structure fabricated as described herein using a separate process and separate coating materials to increase the surface roughness of the exposed surface of the composite structure. When the composite structure as disclosed herein further includes a separately applied AF coating, it may exhibit a water repelling property with a contact angle of 110° or greater. Thus, the AF characteristics of the composite structure can be additionally improved by additionally applying an AF coating. Suitable additional AF coatings may include alumina, silica, PMMA resin or fluorine-based coating agents, but embodiments of the present disclosure are not limited thereto.

In one embodiment, an oleophobic coating may be applied to the surface of a (coated) composite structure as described herein to provide anti-smudging and anti-fingerprint properties. Oleophobic coatings and application techniques, such as those described in U.S. Patent Publication 2014/0087197, are suitable and may be used in combination with materials and processes described herein. More particularly, a transitional layer and surface coating as described in U.S. Patent Publication 2014/0087197 may be applied to composite structures, and particularly to sapphire-coated composite structures as described herein.

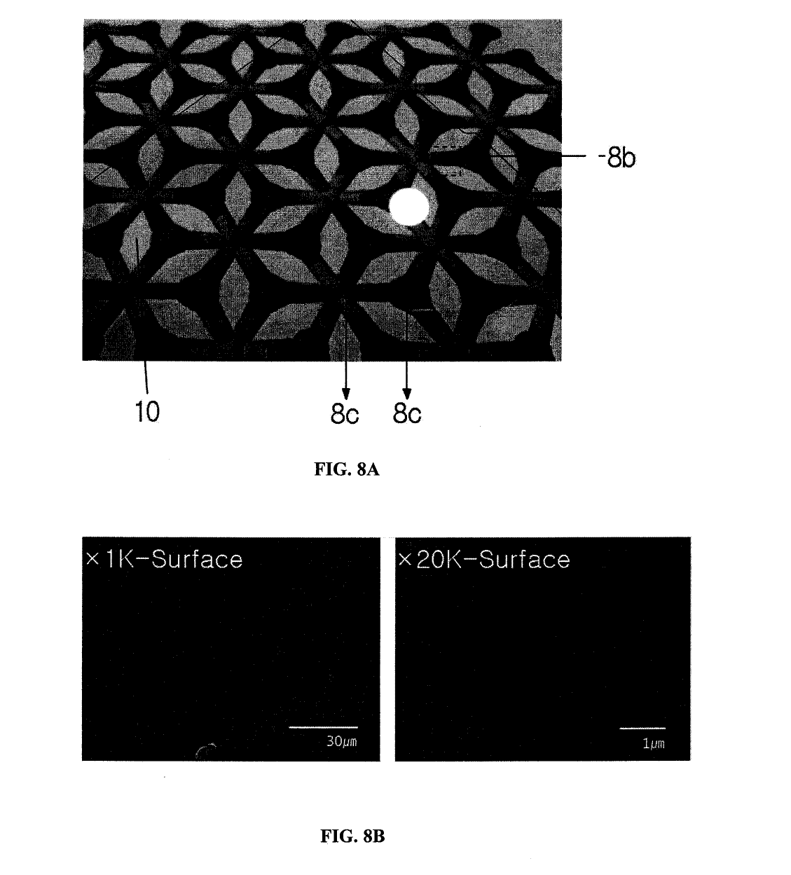

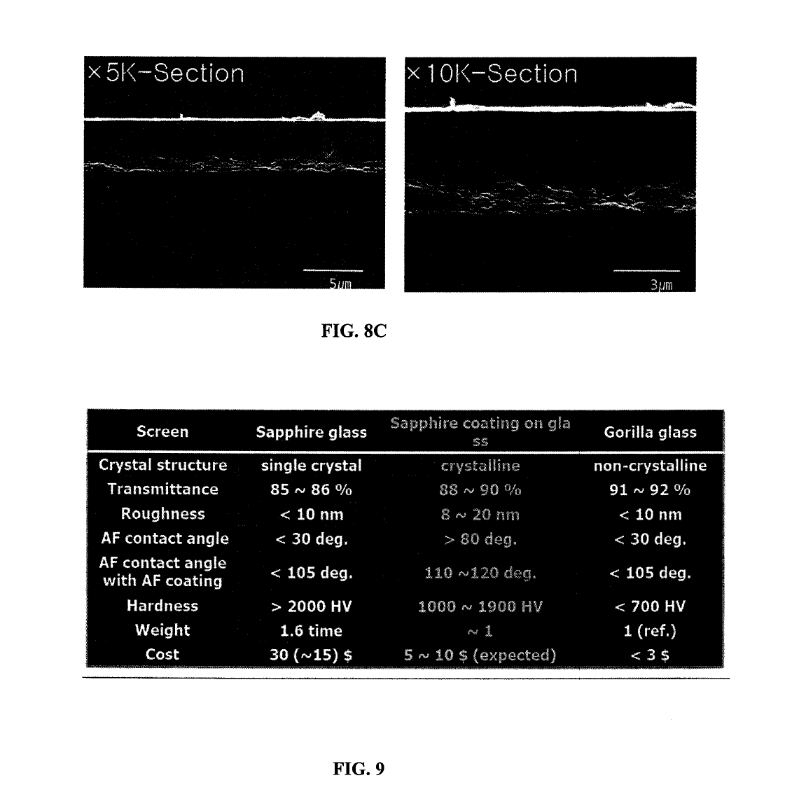

FIGS. 8A to 8C are photographs of a sapphire-coated GORILLA GLASS composite structure according to an embodiment of the present invention. Specifically, FIG. 8A illustrates a photograph of a composite structure comprising sapphire-coated GORILLA GLASS, wherein the coating is formed of alpha-alumina and has a thickness of 1 μm. FIG. 8B illustrates enlarged photographs of a portion ‘8b’ of FIG. 8A, magnified by 1K times and 20K times using an electron microscope, and FIG. 8C illustrates enlarged photographs of a portion taken along the line 8c-8c of FIG. 8A, magnified by 5K times and 10K times using an electron microscope.

As is evident from the photographs shown in FIGS. 8A to 8C, the sapphire-coated GORILLA GLASS composite structure has high transparency so that its lower portion can be transparently seen. In addition, as confirmed from the cross-sectional view shown in FIG. 8C, the coating formed on the composite structure when ceramic powder collides with a surface of the substrate is pulverized and has a small particle size. In addition, the coating has a generally uniform surface even without a separate processing step.

Coatings as described herein may be applied to a variety of substrates to provide many different composite structures having different properties that may be used in various fields. For example, substantially transparent composite structures may be used as a transparent substrate in a variety of objects employing optical windows, mirrors, lenses, and the like. Composite structures, as described herein, may be employed in a variety of substantially planar display products, such as displays for electronic devices (e.g., phones, tablets, handheld devices, wearable displays, computers, monitors, watches, and the like). Coatings as described herein may also be applied to different types of substrates, such as curved substrates used as displays for watches and other electronic devices, flexible substrates used as displays for various types of electronic devices, and three dimensional substrates having a variety of compositions and surface configurations and characteristics, such as metallic, plastic and ceramic frames, cases and other objects. Coated substrates including display devices and many other types of devices are contemplated and, as described herein, are considered to form a part of the invention.

In some applications, for example, coatings as described herein may be applied to cases and frames comprising metal, ceramics, glass, plastic, fiber reinforced materials, and the like to enhance the hardness, scratch resistance, or other properties of the substrate material. In some applications, coatings as described herein may be applied to three dimensional objects, such as medical devices, medical implants, sporting equipment, scientific and electronic components and equipment, and the like, to provide improved surface properties. Exemplary coatings and applications include (and are not limited to) the following: transparent high dielectric/electrode coatings comprising M-doped ZnO, BTO, STO, AZO, and the like; thick metal magnet and ferrite coatings comprising NiZn Ferrite, Nd/Sm-base magnets; and Metal PCB, AIN, ZrO and bio-ceramics. It will be appreciated that the coatings and coating techniques described herein may be used in connection with a wide variety of substrate materials having a wide variety of compositions, configurations, properties, surface structures, and the like.

While the coating process described in detail herein is directed to application of a substantially uniform coating on a substrate, multiple coating layers (composed o f the same or different coating compositions) may be applied to substrates to provide composite structures having multiple coating layers with the same or different properties. It will also be appreciated that while the coating process described in detail herein is directed to application of a substantially uniform coating on a substrate, substantially the same process may be used to provide desired patterning (i.e., a non-uniform surface layer) of one or more coatings on a substrate. Multiple coatings may be applied using a patterning technique to provide surface areas having different coating compositions and, thus, different properties. It will also be appreciated that additional coating compositions may be applied to a substrate, or to a coated substrate, using different techniques and different compositions.

In particular embodiments, compositions and methods for forming nano-sized crystalline sapphire coatings are provided. Composite structures comprising nano-sized crystalline sapphire coatings on glass and plastic substrates including, in particular, GORILLA GLASS, are provided. These composite structures have advantageous properties compared to both GORILLA GLASS alone, and compared to Sapphire glass, including advantageous transmittance, hardness, weight and cost properties. A summary of comparative properties is shown in FIG. 9.

While coatings and coated composite structures having improved transparency and scratch resistance and forming methods thereof according to the present disclosure have been particularly shown and described with reference to exemplary embodiments thereof, it will be understood by those of ordinary skill in the art that various changes in form and details may be made therein without departing from the spirit and scope of the present disclosure as defined by the following claims. It is therefore desired that the present embodiments be considered in all respects as illustrative and not restrictive, reference being made to the appended claims rather than the foregoing description to indicate the scope of the invention.

1. A method for applying a coating on a transparent substrate to fabricate a transparent composite structure, comprising: conveying coating particulates mixed with gas, to a processing chamber and spraying coating particulates on the transparent substrate in the processing chamber to provide a coated transparent substrate, wherein a bending angle (C) of the transparent composite structure is in a range of 0.05° to 3°.

2. (canceled)

3. (canceled)

4. (canceled)

5. (canceled)

6. (canceled)

7. (canceled)

8. The method of claim 1, wherein the coating particulates comprise one or a mixture of two materials selected from the group consisting of alpha alumina (α-Al₂O₃), alumina (Al₂O₃), yttria (Y₂O₃), YAG (Y₃Al₅O₁₂), a rare earth element series (atoms ranging from atom numbers 57 to 71, including Y and Sc) oxide, bio glass, silicon dioxide (SiO₂), hydroxyapatite, titanium dioxide (TiO₂), calcium phosphate, Pb(Zr,Ti)O₃ (PZT), zirconia (ZrO₂), yttria stabilized zirconia (YSZ), dysprocia (Dy₂O₃), gadolinia (Gd₂O₃), ceria (CeO₂), gadolinia doped ceria (GDC), magnesia (MgO), barium titanate (BaTiO₃), nickel manganite (NiMn₂O₄), potassium sodium niobate (KNaNbO₃), bismuth potassium titanate (BiKTiO₃), bismuth sodium titanate (BiNaTiO₃), CoFe₂O₄, NiFe₂O₄, BaFe₂O₄, NiZnFe₂O₄, ZnFe₂O₄, MnₓCo₃₋ₓO₄ (where x is a positive real number of 3 or less), bismuth ferrite (BiFeO₃), bismuth zinc niobate (Bi₁₋₅Zn₁Nb_{1.5}O₇), lithium phosphate aluminum titanium glass ceramic, Li—La—Zr—O based garnet oxide, Li—La—Ti—O based perovskite oxide, La—Ni—O based oxide, iron lithium phosphate, lithium-cobalt oxide, Li—Mn—O based spinel oxide, lithium phosphate aluminum gallium oxide, tungsten oxide, tin oxide, nickel lanthanum oxide, lanthanum-strontium-manganese oxide, lanthanum-strontium-iron-cobalt oxide, silicate based phoshor, SiAlON based phosphor, aluminum nitride, silicon nitride, titanium nitride, AION, silicon carbide, titanium carbide, tungsten carbide, magnesium boride, titanium boride, a mixture of metal oxide and metal nitride, a mixture of metal oxide and metal carbide, a mixture of ceramic and polymer, a mixture of ceramic and metal, nickel, copper, and silicon.

9. (canceled)

10. (canceled)

11. (canceled)

12. (canceled)

13. The method of claim 1, wherein the transparent substrate comprises a glass composition, GORILLA GLASS, a plastic composition, a polycarbonate (PC) composition, a polyamide (PA) composition, a polyimide (PI) composition, a polybutylene terephthalate (PBT) composition, a polyethylene terephthalate (PET) composition, a poly-ether imide (PEI) composition, a polyphenylene sulfide (PPS) composition, a polyether ketone OPEK) composition, a polyether ether ketone (PEEK) composition, a polymethyl methacrylate (PMMA) composition, a sapphire composition, a metal composition, a ceramic composition, or a fiber reinforced composition.

14. A transparent composite structure comprising a transparent substrate selected from the group of: a glass composition, GORILLA GLASS, a plastic composition, a polycarbonate (PC) composition, a polyamide (PA) composition, a polyimide (PT) composition, a polybutylene terephthalate (PBT) composition, a polyethylene terephthalate (PET) composition, a polyether imide (PEI) composition, a polyphenylene sulfide (PPS) composition, a polyether keton (PEK) composition, a polyether ether ketone (PEEK) composition, a polymethyl methacrylate (PMMA) composition, a sapphire compositions, a metal composition, a ceramic composition, or a fiber-reinforced composition having a coating applied thereto, wherein the coating is selected from the group consisting of: alumina (Al₂O₃), yttria (Y₂O₃), YAG (Y₃Al₅O₁₂), a rare earth element series (atoms ranging from atom numbers 57 to 71, including Y and Sc) oxide, bio glass, silicon dioxide (SiO₂), hydroxyapatite, and titanium dioxide (TiO₂) thereof, and mixtures thereof, and the thickness of the coating is from about 20 nm to about 10 μm, wherein a bending angle (C) of the transparent composite structure is in a range of 0.005° to 3°.

15. The transparent composite structure of claim 14, wherein the thickness of the coating is from about 50 nm to about 5 μm.

16. (canceled)

17. (canceled)

18. (canceled)

19. The transparent composite structure of claim 14, wherein the hardness of the transparent composite structure is at least 1.5 times greater than the hardness of the transparent substrate.

20. The transparent composite structure of claim 14, wherein the transmittance of the transparent composite structure is at least 95% the transmittance of the transparent substrate.

21. (canceled)

22. The transparent composite structure of claim 14, exhibiting a surface contact angle with respect to water of 60° or greater.

23. The transparent composite structure of claim 14, exhibiting an average surface roughness of 5 nm or greater.

24. The transparent composite structure of claim 14, additionally comprising an oleophobic coating applied to the surface of the composite structure.

25. The transparent composite structure of claim 14, additionally comprising an AF coating applied to the surface of the transparent composite structure, wherein the AF coating comprises a composition selected from the group consisting of alumina, silica, PMMA resin and fluorine-based coating agents.

26. The transparent composite structure of claim 14, wherein the transparent substrate comprises a transmissive optical window.

27. The transparent composite structure of claim 14, wherein the transparent substrate is planar and transmissive and is suitable for use as a display for an electronic device.

28. The transparent composite structure of claim 14, wherein the transparent substrate is curved and transmissive and is suitable for use as a display for electronic devices.

29. The transparent composite structure of claim 14, wherein the transparent substrate is flexible and is substantially transmissive and is suitable for use as a display for electronic device.

30. (canceled)

31. (canceled)
